(19) United States
(12) Patent Application Publication
(10) Pub. No.: US 2026/0037144 A1
(43) Pub. Date: Feb. 5, 2026

(54) PROGRAM AND READ OPERATIONS USING UNBALANCED READ WINDOW BUDGETS ACROSS PAGE TYPES

(71) Applicant: Micron Technology, Inc., Boise, ID (US)

(72) Inventors: Jun Wan, San Jose, CA (US); Ying Yu Tai, Mountain View, CA (US); Jiangli Zhu, San Jose, CA (US); Zhenming Zhou, San Jose, CA (US); Peng Zhang, Los Altos, CA (US)

(21) Appl. No.: 18/791,158

(22) Filed: Jul. 31, 2024

(51) Int. Cl. G06F 3/06

(52) U.S. Cl. CPC G06F 3/0619; G06F 3/0659; G06F 3/0679

(57) ABSTRACT

A processing device identifies a victim page type and a benefactor page type. The processing device selects a target wordline from a set of wordlines, wherein the target wordline is connected to a set of memory cells associated with the victim page type and the benefactor page type. The processing device allocates a portion of a read window budget (RWB) corresponding to the victim page type to the benefactor page type, wherein the RWB represents a margin between neighboring threshold voltage distributions of memory cells.

### TECHNICAL FIELD

Embodiments of the disclosure relate generally to memory sub-systems, and more specifically, relate to performing program and read operations using unbalanced read window budgets (RWBs) across page types.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system, in accordance with some embodiments of the present disclosure.

FIG. 2 is a flow diagram of an example method of performing read operations using unbalanced RWBs, in accordance with some embodiments of the present disclosure.

FIG. 3 is a diagram illustrating adjusting RWBs based on page type, in accordance with some embodiments of the present disclosure.

FIG. 4 is a chart illustrating the effect of performing read operations with unbalanced RWBs, in accordance with some embodiments of the present disclosure.

FIG. 5 is a block diagram of an example computer system in which embodiments of the present disclosure may operate.

### DETAILED DESCRIPTION

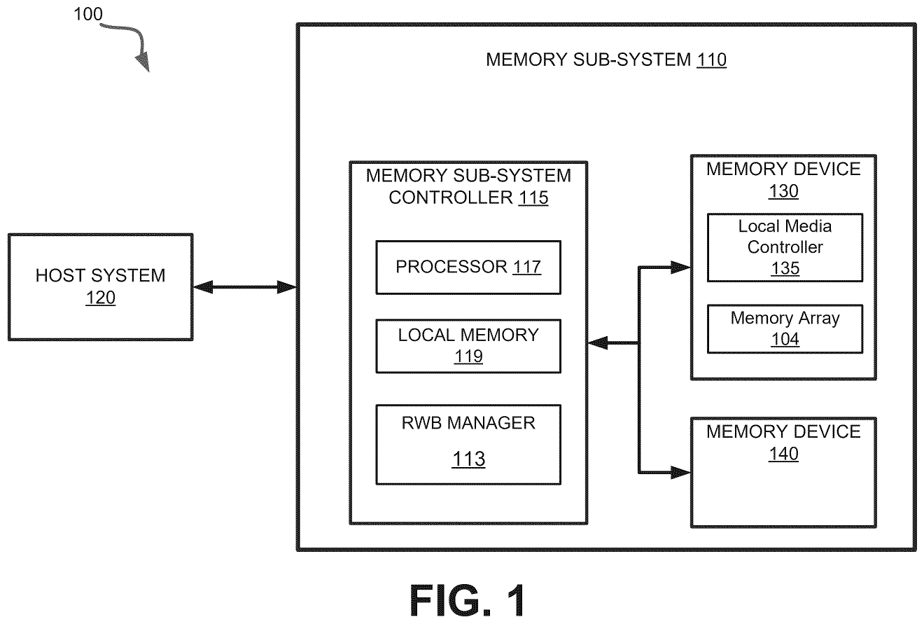

Aspects of the present disclosure are directed to read operations using unbalanced RWBs. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can includes of one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits, and has various logic states that correlate to the number of bits being stored. The logic states can be represented by binary values, such as “0” and “1”, or combinations of such values.

A memory device can include multiple memory cells arranged in a two-dimensional or a three-dimensional grid. The memory cells can be formed onto a silicon wafer in an array of columns and rows. A bitline can refer to one or more conductive lines coupled to a column of associated memory cells in a memory device. A wordline can refer to one or more conductive lines coupled to a row of associated memory cells in a memory device that are used with one or more bitlines to generate the address of each of the memory cells. The intersection of a bitline and a wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For case of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

Various data operations can be performed by the memory sub-system. The data operations can be host-initiated operations. For example, the host system can initiate a data operation (e.g., write, read, erase, etc.) on a memory sub-system. The host system can send access requests (e.g., write command, read command) to the memory sub-system, such as to store data on a memory device at the memory sub-system and to read data from the memory device on the memory sub-system.

During a read operation, the processing logic within the memory subsystem is determining the data stored in a memory cell. This is achieved by identifying which predetermined threshold voltage distribution the cell's measured threshold voltage falls within. Threshold voltages are used to represent different data states but due to various factors, including manufacturing variances, wear, and temperature fluctuations, the charge stored in a cell—and thus its voltage level—can vary. This variance results in a distribution of threshold voltages (e.g., a “threshold voltage distribution”) for each voltage level. The spaces between these threshold voltage distributions (hereafter referred to as “valleys”) are used to differentiate between the threshold voltage distributions representing each possible data value. The valleys are defined as read window budget (RWB), the margin between neighboring threshold voltage distributions. The read operation is executed by applying a read voltage and then comparing the cell's measured threshold voltage against this applied voltage to determine its threshold voltage distribution. The sense amplifier detects these small changes in voltage against a reference voltage and amplifies them to a full digital logic level, thus ensuring the accurate and reliable retrieval of data. In some embodiments, a single memory cell can be configured to store multiple bits of information: a memory cell operated with 2n different threshold voltage levels is capable of storing n bits of information. Thus, a read operation can be performed by comparing the measured voltage exhibited by the memory cell to one or more reference voltage levels in order to distinguish between two logical levels for single-level cells and between multiple logical levels for multi-level cells.

The size of the valleys impacts the reliability of a memory device. These valleys enable the accurate differentiation of stored data states. As such, narrower valleys can increase the likelihood of read errors. The “weakest” wordline in a memory array can be characterized as having the lowest aggregated RWB between threshold voltage distributions. The aggregated RWB is the sum of all RWBs for a wordline. When the weakest wordline exhibits narrow valleys, it becomes more challenging to distinguish between these states, increasing the likelihood of read errors. This necessitates more conservative read operations and enhanced error correction operations, which, in turn, can slow down the overall performance of the memory sub-system.

As the memory device's performance is constrained by its weakest wordline, the maximum operational performance is inherently limited. Although other wordlines and pages can support higher performance levels, the necessity to accommodate the limitations of the weakest wordline prevents the system from reaching its full potential. This leads to unrealized performance, as the memory sub-system is unable to operate at its maximum speed due to the constraints of the weakest components.

Furthermore, increasing performance despite the weakest wordline results in a high Raw Bit Error Rate (RBER). RBER measures the frequency of errors in data and is defined as the ratio of erroneous bits to the total number of bits read from the memory. A high RBER indicates a higher occurrence of bit errors, posing challenges to error correction mechanisms in maintaining data integrity.

Error correcting code (ECC) is used to detect and correct data errors in memory systems. In ECC, data is organized into codewords, which are data units that include the original data bits combined with additional parity bits. The capability of ECC to correct errors is determined by the number of parity bits included in each codeword; more parity bits allow for correction of a greater number of errors (e.g., can handle a higher RBER). The additional parity bits are used to identify and correct errors by checking whether the parity of the received data matches the expected parity. A number of bits of the data received by the system may have been altered due to noise, interference, distortion, bit synchronization errors, or errors from the media itself (both intrinsic and extrinsic). For example, a bit originally stored as a 0 may be flipped to a 1 or vice versa.

If the parity of the received data does not match the expected parity, an error is detected, and ECC mechanisms can then work to correct the error and maintain data integrity. These codewords ensure that any errors introduced during storage or transmission can be detected and corrected, preserving the reliability and integrity of the data. However, a high RBER can overwhelm the ECC, potentially compromising data integrity and leading to data loss or corruption. Thus, pushing performance beyond the limitations of the weakest wordline risks exceeding ECC capabilities.

Aspects of the present disclosure address the above and other deficiencies by having a memory sub-system that can perform program and read operations using “unbalanced” RWBs. Specifically, instead of allocating equal RWBs for pages of each page type, the system of the present disclosure re-distributes RWB from memory cells associated with a page type (e.g., a “victim page type”) to another (e.g. a “benefactor page type”) in the weakest wordline. In some embodiments, there can be multiple victim page types and multiple benefactor page types. In addition, in some embodiments, the victim page type and a benefactor page type are arbitrarily selected. By gaining RWB, operations involving the benefactor page type can gain a performance increase without the risk of overwhelming ECC capabilities.

Furthermore, the present disclosure addresses a reliability issue that can arise with the reduced RWB of the victim page type. The decreased Read Window Budget (RWB) can result in a high RBER, overwhelming the capabilities of the associated ECC. To mitigate this issue, the processing device can enhance the ECC capabilities for the victim page type by adding more parity bits to the codewords associated with these pages. In some embodiments, this involves sacrificing a codeword associated with the victim page type and reallocating its bits to the remaining codewords of that page type as ECC parity bits, thereby bolstering the ECC capabilities of the victim page type to counteract the reduced RWB.

Advantages of the present disclosure includes, but is not limited to, higher reliability with increased performance. By performing program and read operations using “unbalanced” RWBs across page types, the system allows pages of a wordline to operate at higher performance levels than with “balanced” RWBs (e.g., equal RWBs across page types). Furthermore, by increasing the ECC parity bits for codewords associated with the victim page type to be greater than that of benefactor page types, the system can better manage the higher RBER from reducing the victim page RWB, reducing the likelihood of data loss and enhancing overall memory reliability. Consequently, the system can also achieve higher performance levels without inducing high trigger rates and the associated latency.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a RWB manager component 113 that can perform read operations with unbalanced RWBs. In some embodiments, the memory sub-system controller 115 includes at least a portion of the RWB manager component 113. In some embodiments, the RWB manager component 113 is part of the host system 120, an application, or an operating system. In other embodiments, local media controller 135 includes at least a portion of RWB manager component 113 and is configured to perform the functionality described herein.

The RWB manager component 113 can perform program and read operations using unbalanced RWBs across page types. The RWB manager component re-distributes RWB from memory cells associated with a page type (e.g., a “victim page type”) to another (e.g. a “benefactor page type”) in the weakest wordline. By gaining RWB, operations involving the benefactor page type can gain a performance increase without the risk of overwhelming ECC capabilities. Furthermore, the RWB manager component 113 can enhance the ECC capabilities for the victim page type by adding more parity bits to the codewords associated with these pages, thereby bolstering the ECC capabilities of the victim page type to counteract the reduced RWB. Further details with regards to the operations of the RWB manager component 113 are described below.

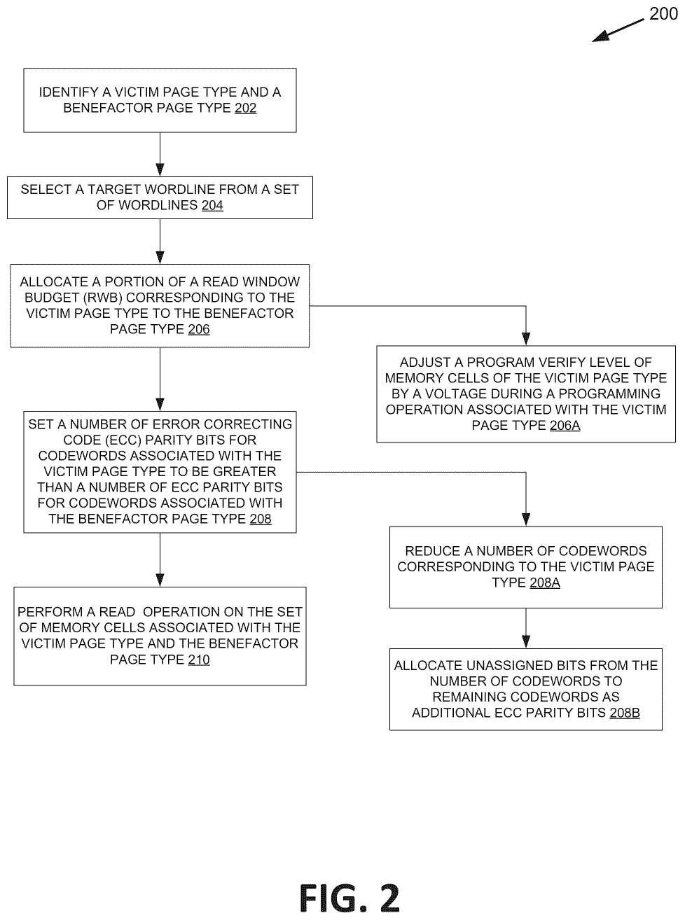

FIG. 2 is a flow diagram of an example method 200 for performing read operations with unbalanced RWBs, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the RWB manager component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 202, the processing logic identifies a victim page type and a benefactor page type. Different embodiments can have different page types. For example, in an embodiment where the memory device is configured to store three bits per memory cell (e.g., TLC in NAND memory), page types can include lower page (LP), upper page (UP), and extra page (XP). Different page types can have varying performance characteristics or priorities within the memory controller's logic, influencing how data is read from, written to, or erased on these pages.

In some embodiments, the victim page type and benefactor page type are predetermined. In some embodiments the victim page type and benefactor page type are arbitrarily selected by the processing logic. In some embodiments, there can be multiple benefactors page types and/or multiple victim page types. For example, in an embodiment where the memory device is configured to store three bits per memory cell (e.g., TLC), the processing logic may have selected page type UP as the victim page type and page types LP and XP as the benefactor page types.

At operation 204, the processing logic selects a target wordline from a set of wordlines of a memory device. In some embodiments, the target wordline is the wordline with the lowest cumulative RWB of the set of wordlines (e.g., a weakest wordline). This embodiment prioritizes the most error-prone wordline. Other embodiments can select target wordlines based on a reliability metric, such as RBER.

At operation 206, the processing logic allocates a portion of the RWB corresponding to the victim page type to the benefactor page type. In some embodiments, allocating the portion of the RWB corresponding to the victim page type to the benefactor page type comprises distributing the portion of the RWB across multiple benefactor page types based on a target distribution. Furthermore, in some embodiments, the processing logic distributes the portion of the RWB from multiple victim page types to the benefactor page type based on a target distribution. For example, in an embodiment where the memory device is configured to store three bits per memory cell (e.g., TLC) a target distribution can be the even 50/50 distribution of RWB from pages of victim page type UP to the RWB associated with benefactor page types LP and XP. Other embodiments in this scenario can prioritize the RWB of a benefactor page type over another benefactor page type and distribute RWB unevenly across the benefactor page types.

In some embodiments, at operation 206A, allocating the portion of the RWB corresponding to the victim page type to the benefactor page type comprises adjusting a program verify level of pages of the victim page type. The program verify level in memory devices is a voltage level used during the programming of memory cells to confirm that they have reached the correct threshold voltage for the data they are intended to store. This level is checked after each programming pulse; if the cell's voltage isn't high enough, additional pulses are applied until it meets or exceeds this verify level, ensuring accurate data storage. Adjusting the program verify level in programming operations for a particular page type shifts the positions of the memory cells of the pages for that page type. As such, the RWB for a memory of a page type can be directly affected by adjusting the corresponding program verify level.

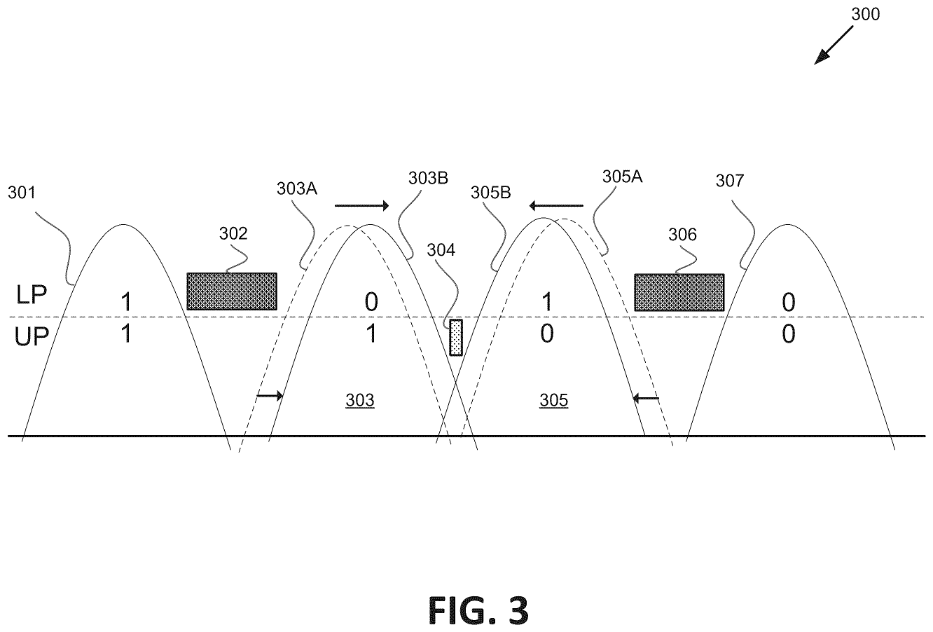

FIG. 3 is a diagram 300 illustrating adjusting RWBs based on page type, in accordance with some embodiments of the present disclosure. The example implementation depicted is of a memory device configured to store two bits per cell (e.g., a multi-level cell (MLC). MLC memory devices have four voltage levels, each voltage level corresponding to a threshold voltage distribution. Threshold voltage distributions 301, 303A-B, 305A-B, and 307 are threshold distributions comprising memory cells with similar characteristics. A threshold voltage distribution refers to the range of voltage levels that correspond to different stored states in a memory cell. In multi-level cell (MLC) technology, each cell has multiple threshold voltages, each representing a unique combination of bits (e.g., 00, 01, 10, 11). These distinct voltage levels ensure that the memory cell can accurately store and retrieve multiple bits of information.

In some embodiments, each threshold voltage distribution (hereafter referred to as a “distribution”) comprises a number of page types. In the MLC embodiment depicted in FIG. 3, there are two page types, lower page (LP) and upper page (UP). In the diagram 300, memory cells associated with pages of the page type UP are depicted in region UP, here comprising the logic state binary values 1 (in distribution 302), 1 (in distribution 303), 0 (in distribution 305), and 0 (in distribution 307). Other embodiments may comprise different logic state binary values. In the diagram 300, memory cells associated with pages of the page type LP are depicted in region LP, here comprising the logic state binary values 1 (in distribution 302), 0 (in distribution 303A-B), 1 (in distribution 305A-B), and 0 (in distribution 307).

FIG. 3 depicts an example where the processing logic allocates RWB associated with the page type UP to the page type LP. As a part of this allocating, distribution 303 shifts from position 303A to position 303B and distribution 305 shifts from position 305A to position 305B. The result is unequal (e.g., “unbalanced”) RWBs 302, 304, and 306; the read window budget formerly allocated to UP RWB 304 is reallocated to LP RWBs 302 and 306.

At operation 208, the processing logic sets a number of error correcting code (ECC) parity bits for codewords associated with the victim page type to be greater than a number of ECC parity bits for codewords associated with the benefactor page type. Codewords are data units that combine original data bits with additional parity bits. The parity bits allow the system to check if the parity of received data matches the expected parity, effectively detecting discrepancies caused by various factors such as noise, interference, distortion, and bit synchronization errors, as well as intrinsic or extrinsic errors from the storage media itself. The capability of ECC to correct errors is determined by the number of parity bits included in each codeword; more parity bits allow for correction of a greater number of errors (e.g., can handle a higher RBER). By increasing the ECC parity bits for codewords associated with the victim page type, the system can better manage higher error frequency, reducing the likelihood of data loss and enhancing overall memory reliability.

In some embodiments, each page type has a number of associated codewords. In some embodiments, at operation 208A, in setting a number of ECC parity bits for codewords associated with the victim page type to be greater than a number of ECC parity bits for codewords associated with the benefactor page type, the processing logic reduces the number of codewords corresponding to the victim page type. For example, in an embodiment, the number of codewords is decreased by one. This is for minimal sacrifice of host-data capacity.

At operation 208B, the processing logic allocates unassigned bits from the number of codewords to remaining codewords as additional ECC parity bits. The processing device adds more parity bits to the codewords associated with these pages. In some embodiments, this involves sacrificing a codeword associated with the victim page type and reallocating its bits to the remaining codewords of that page type as ECC parity bits, thereby bolstering the ECC capabilities of the victim page type to counteract the reduced RWB. The capabilities of error correcting code is limited by the number of ECC parity bits. As such, the more ECC parity bits allocated to the page type, the greater the error-correcting capabilities of the ECC.

In embodiments, at operation 210, the processing logic performs a read operation on the set of memory cells associated with the victim page type and the benefactor page type.

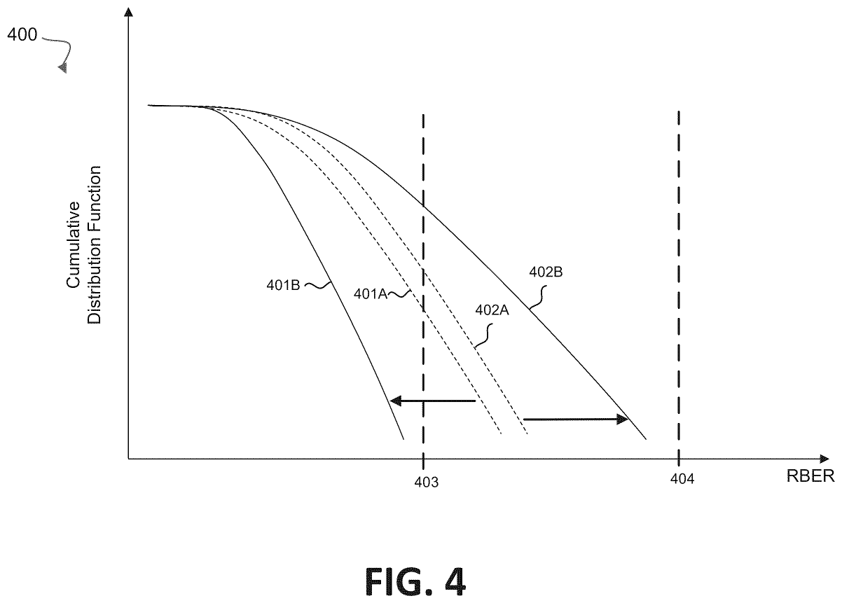

FIG. 4 is a chart 400 illustrating the effect of performing read operations with unbalanced RWBs, in accordance with some embodiments of the present disclosure. The x-axis of chart 400 corresponds to the Raw Bit Error Rate (RBER), which measures the frequency of erroneous bits read from the target wordline. The y-axis corresponds to a cumulative distribution function representing pages across the target wordline. Each point on the curves 401A-B and 402A-B represents the RBER for a page associated with a page type. ECC thresholds 403 and 404 are the points at which the RBER of a page overwhelms the capabilities of the ECC.

Using the embodiment depicted in FIG. 3, curves 401A and 402A represent the frequency of read errors (e.g., RBER) for pages associated with page type LP and UP, respectively. Curves 401A and 402A are associated with an implementation using balanced RWBs across page types in a target wordline.

In this example, at operation 206, the processing logic redistributes a portion of the Read Window Budget (RWB) from a victim page type (e.g., Upper Page, UP) to a benefactor page type (e.g., Lower Page, LP). Consequently, this redistribution results in the shift of curve 401A to curve 401B in chart 400, maintaining it within the limits set by ECC threshold 403. Simultaneously, the reduction in RWB for the victim page causes a corresponding shift from curve 402A to curve 402B, exceeding the limits set by ECC threshold 403.

At operation 208, the processing logic sets the number of ECC parity bits for codewords associated with the victim page type to be greater than the number of ECC parity bits for codewords associated with the benefactor page type. As a result, the capability of the ECC for the victim page type is raised to ECC threshold 404, allowing for reliability to be maintained with the reduced RWB.

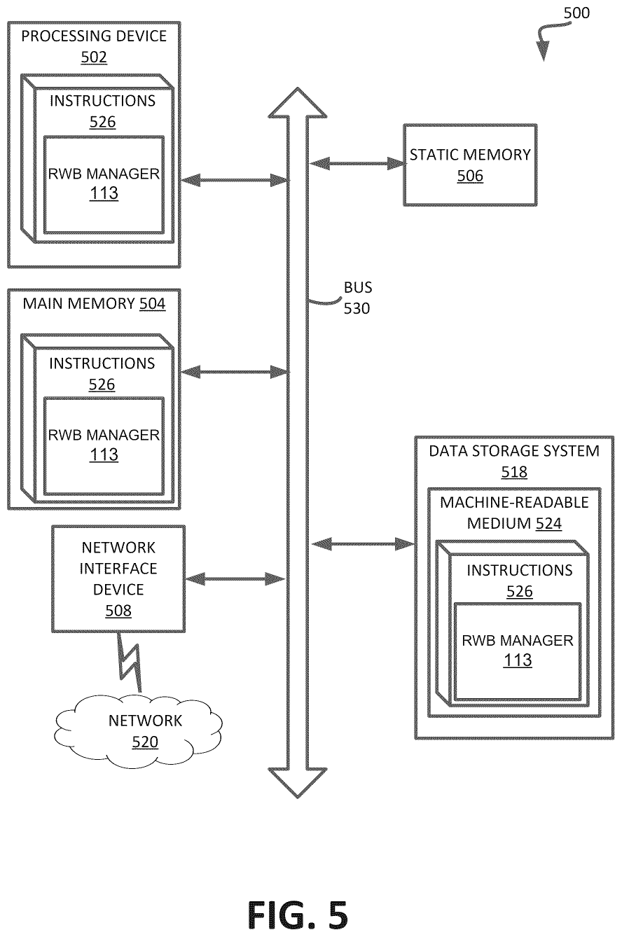

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the RWB manager component 113 of FIG. 1). In alternative embodiments, the machine can be connected (e.g., networked) to other machines in a LAN, an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a RWB manager component (e.g., the RWB manager component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising:
a memory device; and
a processing device, operatively coupled with the memory device, to perform operations comprising:
identifying a victim page type and a benefactor page type;
selecting a target wordline from a set of wordlines, wherein the target wordline is connected to a set of memory cells associated with the victim page type and the benefactor page type; and
allocating a portion of a read window budget (RWB) corresponding to the victim page type to the benefactor page type, wherein the RWB represents a margin between neighboring threshold voltage distributions of memory cells.

2. The system of claim 1, further comprising:
performing a read operation on the set of memory cells associated with the victim page type and the benefactor page type.

3. The system of claim 1, wherein the target wordline has a lowest cumulative RWB of the set of wordlines.

4. The system of claim 1, further comprising:
setting a number of error correcting code (ECC) parity bits for codewords associated with the victim page type to be greater than a number of ECC parity bits for codewords associated with the benefactor page type, wherein a codeword comprises user data and the ECC parity bits.

5. The system of claim 4, wherein increasing the ECC parity bits for the codewords associated with the victim page type comprises:
reducing a number of codewords corresponding to the victim page type; and
allocating unassigned bits from the number of codewords to remaining codewords as additional ECC parity bits.

6. The system of claim 5, wherein the number of codewords corresponding to the victim page type is decreased by one.

7. The system of claim 1, wherein allocating the portion of the RWB corresponding to the victim page type to the benefactor page type comprises:
adjusting a program verify level of memory cells of the victim page type.

8. The system of claim 1, wherein allocating the portion of the RWB corresponding to the victim page type to the benefactor page type comprises distributing the portion of the RWB across multiple benefactor page types based on a target distribution.

9. The system of claim 1, wherein allocating the portion of the RWB corresponding to the victim page type to the benefactor page type comprises distributing the portion of the RWB from multiple victim page types to the benefactor page type based on a target distribution.

10. A method comprising:
identifying, by a processing device, a victim page type and a benefactor page type;
selecting a target wordline from a set of wordlines, wherein the target wordline is connected to a set of memory cells associated with the victim page type and the benefactor page type; and
allocating a portion of a read window budget (RWB) corresponding to the victim page type to the benefactor page type, wherein the RWB represents a margin between neighboring threshold voltage distributions of memory cells.

11. The method of claim 10, further comprising:
performing a read operation on the set of memory cells associated with the victim page type and the benefactor page type.

12. The method of claim 10, wherein the target wordline has a lowest cumulative RWB of the set of wordlines.

13. The method of claim 10, further comprising:
setting a number of error correcting code (ECC) parity bits for codewords associated with the victim page type to be greater than a number of ECC parity bits for codewords associated with the benefactor page type, wherein a codeword comprises user data and the ECC parity bits.

14. The method of claim 13, wherein increasing the ECC parity bits for the codewords associated with the victim page type comprises:
reducing a number of codewords corresponding to the victim page type; and
allocating unassigned bits from the number of codewords to remaining codewords as additional ECC parity bits.

15. The method of claim 14, wherein the number of codewords corresponding to the victim page type is decreased by one.

16. The method of claim 10, wherein allocating the portion of the RWB corresponding to the victim page type to the benefactor page type comprises:
adjusting a program verify level of memory cells of the victim page type.

17. The method of claim 10, wherein allocating the portion of the RWB corresponding to the victim page type to the benefactor page type comprises distributing the portion of the RWB across multiple benefactor page types based on a target distribution.

18. The method of claim 10, wherein allocating the portion of the RWB corresponding to the victim page type to the benefactor page type comprises distributing the portion of the RWB from multiple victim page types to the benefactor page type based on a target distribution.

19. A non-transitory computer-readable storage medium comprising instructions that, when executed by a processing device, cause the processing device to perform operations comprising:
identifying, by a processing device, a victim page type and a benefactor page type;
selecting a target wordline from a set of wordlines, wherein the target wordline is connected to a set of memory cells associated with the victim page type and the benefactor page type; and
allocating a portion of a read window budget (RWB) corresponding to the victim page type to the benefactor page type, wherein the RWB represents a margin between neighboring threshold voltage distributions of memory cells.

20. The non-transitory computer-readable storage medium of claim 19, further comprising:
setting a number of error correcting code (ECC) parity bits for codewords associated with the victim page type to be greater than a number of ECC parity bits for codewords associated with the benefactor page type, wherein a codeword comprises user data and the ECC parity bits.
